(19) United States
(12) Patent Application Publication
(10) Pub. No.: US 2020/0383275 A1
(43) Pub. Date: Dec. 10, 2020

(54) PLANT CULTIVATION GREENHOUSE

(71) Applicant: PLANTS LABORATORY, INC., Tokyo (JP)

(72) Inventor: Atsuyuki YUKAWA, Tokyo (JP)

(21) Appl. No.: 16/770,188

(22) PCT Filed: Dec. 7, 2017
(86) PCT No.: PCT/JP2017/044042

§ 371 Date: Jun. 5, 2020

(51) Int. Cl. A01G 7/02; A01G 9/18

(52) U.S. Cl. CPC A01G 7/02; A01G 9/18

(57) ABSTRACT

Disclosed is a plant cultivation greenhouse that can supply carbon dioxide into a plant cultivation room in a way that the plant cultivation room is not easily affected by the temperature of the outside air. The plant cultivation greenhouse (1) according to the invention comprises a plant cultivation room (10) and a carbon dioxide supply means (20), wherein at least one of a wall (11) and a roof (12) of the plant cultivation room (10) is formed by a heat insulator (15), and the carbon dioxide supply means (20) supply outside air containing carbon dioxide into the plant cultivation room (10) from outside of the plant cultivation room (10). The heat insulator (15) is a laminated sheet (150) that is formed by laminating a metal foil (142), such as an aluminum foil, on a sheet substrate (141).

### FIELD OF THE INVENTION

The present invention relates to a plant cultivation greenhouse for cultivating plants in a plant cultivation room.

### BACKGROUND OF THE INVENTION

For a long time, various plant cultivation greenhouses for cultivating plants such as vegetables have been provided. For example, a cultivation room equipped with an air-conditioning device is recorded in patent document 1. In this cultivation room, a lighting device is arranged on the side of the ceiling, and a cultivation frame is equipped on the side of the floor. The air-conditioning device has a first exhaust apparatus, a second exhaust apparatus, a mixing apparatus, and an air-blowing apparatus.

The first exhaust apparatus discharges the air at the side of the ceiling in the cultivation room to outside the cultivation room. The second exhaust apparatus discharges the air at the side of the floor in the cultivation room to outside the cultivation room. The mixing apparatus cools the air discharged by the second exhaust apparatus to form dehumidified air, and mixes the dehumidified air with the air discharged by the first exhaust apparatus. The air-blowing apparatus blows the air mixed by the mixing apparatus to around the cultivation frame in the cultivation room.

The air discharged by the first exhaust apparatus becomes high-temperature air due to the lighting device arranged on the side of the ceiling. The high-temperature air is mixed with the air discharged by the second exhaust apparatus and dehumidified by the mixing apparatus, and then blown into the cultivation room by the air-blowing apparatus. Therefore, the air blown from the air-blowing apparatus is used for the heat dissipation of the lighting device to reach a specified high temperature. Because the cultivation room has an air-conditioning device, energy source can be saved.

### PRIOR ART DOCUMENTS

### Patent Documents

Patent Document 1: Japanese Patent Laid-Open No. 2011-223892

### SUMMARY OF THE INVENTION

### Problems to be Solved by the Invention

The cultivation room recorded in patent document 1 circulates the air in the cultivation room. The plant in the cultivation room absorbs carbon dioxide and releases oxygen. Therefore, the carbon dioxide required for plant growth will be insufficient only by means of the air circulation in the cultivation room. Moreover, even if the air blown into the cultivation room reaches the specified high temperature, when the cultivation room is a plastic shed that is formed by merely covering a framework with a plastic film, it will be affected by the temperature outside the cultivation room.

In view of the above situation, the present invention provides a plant cultivation greenhouse that can supply carbon dioxide into a plant cultivation room in which it is not easily affected by the temperature of the outside air.

### Means for Solving the Problems

In order to solve the above problem, the plant cultivation greenhouse according to the invention includes a plant cultivation room and a carbon dioxide supply means, wherein at least one of a wall and a roof of the plant cultivation room is formed by a heat insulator, and the carbon dioxide supply means supply outside air containing carbon dioxide into the plant cultivation room from outside of the plant cultivation room.

In the plant cultivation greenhouse according to the invention, in the plant cultivation room, the wall and the roof are formed by the heat insulator.

In the plant cultivation greenhouse according to the invention, in the plant cultivation room, the heat insulator is attached to an existing wall substrate and an existing roof substrate to form a wall and a roof.

In the plant cultivation greenhouse according to the invention, preferably, the heat insulator further forms a floor of the plant cultivation room.

In the plant cultivation greenhouse according to the invention, the carbon dioxide supply means supply outside air into the plant cultivation room, so that the plant cultivation room has a positive pressure inside.

In the plant cultivation greenhouse according to the invention, the heat insulator is preferably a laminated sheet formed by laminating an aluminum foil on a sheet substrate.

In the plant cultivation greenhouse according to the invention, preferably, it includes an air-conditioning device for carrying out air conditioning inside the plant cultivation room.

### Effect of the Invention

According to the invention, there provides a plant cultivation greenhouse that can supply carbon dioxide into a plant cultivation room in a way that the plant cultivation room is not easily affected by the temperature of the outside air.

### BRIEF DESCRIPTION OF THE DRAWINGS

FIG. 1 is a schematic stereogram showing an embodiment of a plant cultivation greenhouse according to the invention.

FIG. 2 is a front cutaway view showing an embodiment of a plant cultivation greenhouse according to the invention.

FIG. 3 is an enlarged cutaway view showing an embodiment of a heat insulator forming the plant cultivation greenhouse according to the invention.

FIG. 4 is an exploded stereogram showing other embodiments of the heat insulator forming the plant cultivation greenhouse according to the invention.

### DETAILED DESCRIPTION OF THE EMBODIMENTS

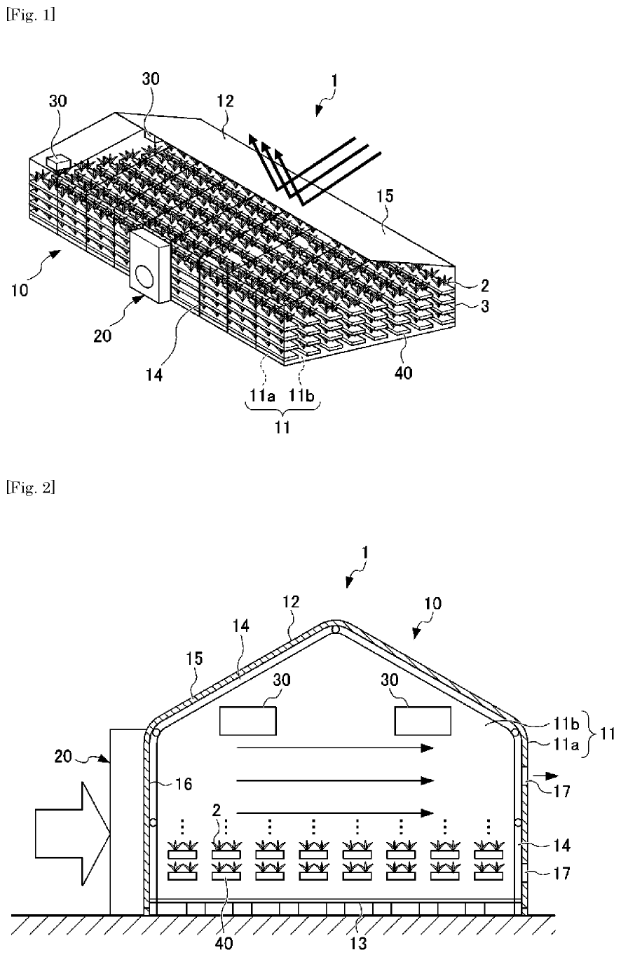

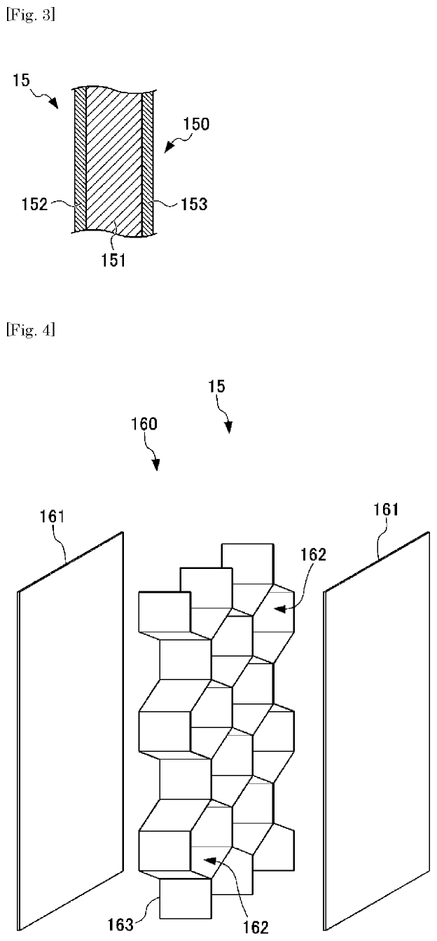

Referring to FIG. 1 to FIG. 3, an embodiment of a plant cultivation greenhouse according to the invention will be illustrated. FIG. 1 is a schematic stereogram showing an embodiment of a plant cultivation greenhouse according to the invention. FIG. 2 is a front cutaway view showing an embodiment of a plant cultivation greenhouse according to the invention. FIG. 3 is an enlarged cutaway view showing an embodiment of a heat insulator forming the plant cultivation greenhouse according to the invention. As shown in FIG. 1 and FIG. 2, the plant cultivation greenhouse 1 includes a plant cultivation room 10 and a carbon dioxide supply means 20.

The plant cultivation room 10 is surrounded by a wall 11, a roof 12 and a floor 13. The wall 11 of the plant cultivation room 10 shown has a gable side wall 11a and a flat side wall 11b. The gable side wall 11a or the flat side wall 11b is provided with a doorway with a door, which is not shown. Although the roof 12 of the plant cultivation room 10 shown is a gable wall, it may have other forms. Such wall 11, roof 12 and floor 13 are formed by a heat insulator 15. The heat insulator 15 is mounted on a framework 14 provided on the ground.

The framework 14 is assembled by a skeleton material made of a metal (for example, stainless steel). The skeleton material may be tubular products, or bar products. The framework 14 is formed by a plurality of pillars and beams, etc. (without reference number) and are provided on the ground. The wall 11 is formed of the heat insulator 15 erected between adjacent pillars. The roof 12 is formed of the heat insulator 15 erected between adjacent beams. The floor 13 is formed of the heat insulator 15 directly provided on the ground or the heat insulator 15 laid on a floor (not shown) on floor support members (short pillars) (not shown), and the floor support members (short pillars) are provided on the ground.

The heat insulator 15 is formed by a laminated sheet 150 shown in FIG. 3. The laminated sheet 150 is a laminated body that takes a sheet material 151 as a core material and coats a metal foil 152 on both sides of the sheet material 151. A fiberglass cloth and a cloth material, etc., may be used as the sheet material 151. An aluminum foil and a steel foil, etc., may be used as the metal foil 152. The adiabaticity of a laminated sheet 150 that coats an aluminum foil on the sheet material 151 is better than the adiabaticity of a laminated sheet 150 that coats aluminum on the sheet material 151 by vaporization. An anti-electrochemical corrosion agent is coated on the metal foil 152 to make the laminated sheet 150 have water resistance, waterproofness, and rust resistance, etc.

The flat side wall 11b on one side is formed with an air-supply hole 16. The flat side wall 11b on the other side is formed with an air vent hole 17. Although FIG. 2 shows that the air-supply hole 16 and the air vent hole 17 are respectively formed at one position, they may be formed at a plurality of positions. Although not shown, the air-supply hole 16 and the air vent hole 17 may also be formed on the gable side wall 11a. Because the specific gravity of carbon dioxide is 1.5, preferably, the wall 11 is formed in the vicinity of the roof 12, so that the carbon dioxide supplied into the plant cultivation room 10 is difficult to be discharged. Preferably, the air vent hole 17 has a shutter that can adjust the opening size.

The carbon dioxide supply means 20 are connected to the air-supply hole 16. The carbon dioxide supply means 20 supply outside air containing carbon dioxide into the plant cultivation room 10 from outside of the plant cultivation room 10. That is, the carbon dioxide supply means 20 supply air, which contains, in addition to carbon dioxide, nitrogen and oxygen, etc., into the plant cultivation room 10. The carbon dioxide supply means 20 have a filter (not shown) that is adapted to prevent insects and pathogenic bacteria, etc., in the outside air from entering the plant cultivation room 10.

The carbon dioxide supply means 20 have an air conditioning function that keeps the temperature and humidity in the plant cultivation room 10 constant by mans of the air supplied into the plant cultivation room 10 from outside of the plant cultivation room 10. The carbon dioxide supply means 20 having the air conditioning function include, for example, a fluid tank, a pipeline and a humidity control apparatus, wherein the fluid tank is adapted to seal a heated or cooled fluid; the pipeline goes through the fluid tank and realizes air circulation; and the humidity control apparatus humidifies or dehumidifies the air inside the pipeline. The pipeline introduces the outside air and discharges it into the plant cultivation room 10.

In summer, the fluid in the fluid tank is cooled. The air flowing into the pipeline is cooled, as spaced by the pipeline, with the aid of the flowing of the fluid inside the fluid tank, and is discharged into the plant cultivation room 10 after being conditioned by the humidity control apparatus. Therefore, the temperature inside the plant cultivation room 10 will not rise due to the supply of the outside air, and the humidity will not change. In winter, the fluid in the fluid tank is heated. The air flowing into the pipeline is heated, as spaced by the pipeline, with the aid of the flowing of the fluid in the fluid tank, and the humidity thereof is conditioned by the humidity control apparatus. Therefore, the temperature inside the plant cultivation room 10 will not decrease due to the supply of the outside air, and the humidity will not change.

Because an air vent hole 17 is formed in the flat side wall 11b on the other side, the outside air can be supplied into the plant cultivation room 10 under the premise that the plant cultivation room 10 is not filled with the air. By forming an air-supply hole 16 and an air vent hole 17 on the walls 11 opposite to each other, a unidirectional air flow is formed.

The air vent hole 17 is configured to make the air discharged from the plant cultivation room 10 is slightly less than the air supplied into the plant cultivation room 10, so that a positive pressure is formed inside the plant cultivation room 10 (if the pressure outside the plant cultivation room 10 is one atmospheric pressure, the pressure inside the plant cultivation room 10 will be larger than one atmospheric pressure). Therefore, even if a gap exists between the wall 11 and the roof 12, insects and pathogenic bacteria, etc., may still be prevented from entering the plant cultivation room 10 from the gap.

The plant cultivation greenhouse 1 has an air-conditioning device 30 for adjusting the temperature and humidity in the plant cultivation room 10. The air-conditioning device 30 has an indoor unit (without reference number) and an outdoor unit (not shown). The indoor unit is fixed to an inner wall of the wall 11 (although it is shown as the gable side wall 11a in the drawing, it may be the flat side wall 11b). Although two air-conditioning devices 30 are provided on the gable side wall 11a on the deep side as shown in the drawing, they may be provided on the gable side wall 11a on the front side. The air-conditioning device 30 may also be provided on the outer side of the plant cultivation greenhouse 1 and adjust the temperature and humidity in the plant cultivation room 10 via an induction pipe or the like that is not shown. In any case, the air-conditioning device 30 circulates the air inside the plant cultivation room 10.

The temperature and humidity of the plant cultivation room 10 set in the air-conditioning device 30 is related to the temperature and humidity of the air adjusted in the carbon dioxide supply means 20 and supplied into the plant cultivation room 10. For example, the temperature and humidity of the carbon dioxide supply means 20 is set as equal to the temperature and humidity set in the air-conditioning device 30. On the contrary, the temperature and humidity of the air-conditioning device 30 may also be set as equal to the temperature and humidity set in the carbon dioxide supply means 20. Or, when a plurality of types of plants are to be placed in the plant cultivation room 10, different types of plants may be placed in the vicinity of the air-supply hole 16 and in the vicinity of the air-conditioning device 30, and air of different temperature and humidity may be blown out from the carbon dioxide supply means 20 and the air-conditioning device 30, thereby attaining the atmosphere suitable for the temperature and humidity of the plant placed in the respective vicinity of thereof.

Shelves 40 for putting a plant 2, such as a vegetable, etc., are placed in the plant cultivation room 10. The shelves 40 are provided on the floor 13. Although it is shown in the drawing that the shelves 40 are arranged in multiple columns, they may be arranged in one column. Although it is shown in the drawing that the shelves 40 are stack in multiple layers, they may be one layer. The floor 13 is formed by the heat insulator 15, thereby preventing the ground temperature from affecting the plant cultivation room 10. Although not shown, a lighting device may be provided in the vicinity, etc., of the ceiling (without reference number) of the plant cultivation room 10.

Here, the status of use of the plant cultivation greenhouse 1 will be illustrated. The plant 2 such as a vegetable, etc., put on the shelves 40 in the plant cultivation room 10 is placed in an atmosphere with a temperature and humidity optimal for the growth as adjusted by the air-conditioning device 30. The lighting device emits light onto the plant 2 at the optimal light quality in the optimal time period.

Because the wall 11 and the roof 12 of the plant cultivation room 10 are formed by the heat insulator 15, hot air and cold air outside the plant cultivation room 10 can be isolated. No matter it is at a high temperature or a lower temperature outside the plant cultivation room 10, it can reach an atmosphere of an expected temperature inside the plant cultivation room 10. The heat insulator 15 is formed by the laminated sheet 150. Moreover, because the laminated sheet 150 is formed by lamination, rather than being a single sheet, the wall 11 and the roof 12 formed by the heat insulator 15 will not dew in winter.

Air containing carbon dioxide is supplied into a plant cultivation room 10 in such an atmosphere from the carbon dioxide supply means 20. Due to the air flow flowing from the air-supply hole 16 to the air vent hole 17 and the air flow from the air-conditioning device 30, the carbon dioxide spreads over to each corner inside the plant cultivation room 10. Because the carbon dioxide supply means 20 have an air conditioning function, the plant cultivation room 10 may be kept at an expected temperature and humidity under the premise that the plant cultivation room 10 is not affected by the outside air.

The plant 2 in the plant cultivation room 10 grows by absorbing carbon dioxide and releasing oxygen. By supplying carbon dioxide into the plant cultivation room 10, insufficiency of carbon dioxide will not appear in the plant cultivation room 10. Therefore, the plant 2 in the plant cultivation room 10 can grow by fully absorbing carbon dioxide.

Air containing the oxygen discharged by the plant 2 is discharged out of the plant cultivation room 10. Additionally, because the plant cultivation room 10 has a positive pressure, insects, and pathogenic bacteria, etc., will not enter the plant cultivation room 10 from the air vent hole 17.

In this manner, the plant cultivation greenhouse 1 can make use of the carbon dioxide supplied by the carbon dioxide supply means 20 into the plant cultivation room 10 from outside of the plant cultivation room 10 to cultivate the plant 2 placed in the plant cultivation room 10 that obtains an atmosphere of expected temperature and humidity via the heat insulator 15.

The plant cultivation greenhouse 1 according to the invention has been illustrated above. However, the invention is not limited to the embodiment, and all variations and improvements made in the scope that can solve the problem of the invention pertain to the invention.

For example, the heat insulator 15 may be formed by a thermal baffle 160 as shown in FIG. 4, rather than the laminated sheet 150. FIG. 4 is an exploded stereogram showing other embodiments of the heat insulator 15.

The heat insulator 15 is a thermal baffle 160, which includes a pair of sheets 161, 161 that are spaced apart and provided opposite to each other, and an enclosed space 162 provided between the pair of sheets 161, 161. The enclosed space 162 is configured via a cellular structure 163. For example, air is sealed in a non-flowable mode in the enclosed space 162. An aluminum foil or a steel foil may be used as the pair of sheets 161, 161. Such a thermal baffle 160 has an adiabaticity due to the enclosed space 162, so that an atmosphere of an expected temperature may be formed inside the plant cultivation room 10.

The wall 11 and the roof 12 of the plant cultivation room 10 may not be formed by the heat insulator 15; instead, the laminated sheet 150 and the thermal baffle may be applied to the wall substrate and roof substrate of an existing plastic shed or various cabins. The wall 11 and the roof 12 of the plant cultivation room 10 will be a wall and a roof that are formed by attaching the heat insulator 15 to a wall substrate and a roof substrate. Additionally, for the plant cultivation greenhouse 1, according to the set environment, the floor 13 may not be formed by the heat insulator 15, or there is no floor 13 actually. Moreover, only one of the wall 11 and the roof 12 may be formed by the heat insulator 15, rather than that both of the wall 11 and the roof 12 are formed by the heat insulator 15.

Although air containing carbon dioxide is supplied by the carbon dioxide supply means 20 into the plant cultivation room 10 from outside of the plant cultivation room 10, carbon dioxide adjusted at any concentration may be supplied into the plant cultivation room 10. In such a case, security of the concentration of carbon dioxide and oxygen is verified before entering the plant cultivation room 10.

Although the air vent hole 17 is provided on the wall 11, in the case that the wall 11 originally has a gap or a gap exists between the door of the doorway and the wall 11, the gap may be regarded as the air vent hole 17, thus no air vent hole 17 needs to be additionally provided.

In conclusion, the plant cultivation greenhouse 1 applicable to the invention includes a plant cultivation room 10 and a carbon dioxide supply means 20, wherein at least one of the wall 11 and the roof 12 of the plant cultivation room 10 is formed by a heat insulator 15, and the carbon dioxide supply means 20 supply outside air containing carbon dioxide into the plant cultivation room 10 from outside of the plant cultivation room 10.

According to the plant cultivation greenhouse 1, at least one of the wall 11 and the roof 12 of the plant cultivation room 10 is formed by the heat insulator 15, thus the temperature and humidity in the plant cultivation room 10 will not be affected by the temperature and humidity outside of the plant cultivation room 10. By supplying outside air containing carbon dioxide into the plant cultivation room 10 from outside of such a plant cultivation greenhouse 1 insufficiency of carbon dioxide will not appear in the plant cultivation room 10, so that the growing of the plant 2 placed in the plant cultivation room 10 may be prompted.

As one mode of the plant cultivation greenhouse 1 applicable to the invention, in the plant cultivation room 10, the wall 11 and the roof 12 are formed by the heat insulator 15. According to the plant cultivation greenhouse, in the plant cultivation room 10, at least one of the wall and the roof can be formed by the heat insulator 15.

As another mode of the plant cultivation greenhouse 1 applicable to the invention, the wall 11 and the roof 12 may be formed by attaching the heat insulator 15 to the existing wall substrate and roof substrate. According to the plant cultivation greenhouse, the plant cultivation room 10 may be formed by applying the heat insulator 15 to the wall substrate and the roof substrate of an existing plastic shed or various cabins.

In the mode of the plant cultivation greenhouse 1 applicable to the invention, the heat insulator 15 further forms the floor 13 of the plant cultivation room 10. According to the plant cultivation greenhouse 1, because the floor 13 is similarly formed by the heat insulator 15, the plant cultivation room 10 is not easily affected by the ground temperature.

As another different mode of the plant cultivation greenhouse 1 applicable to the invention, the carbon dioxide supply means supply outside air into the plant cultivation room, so that the plant cultivation room has a positive pressure inside. According to the plant cultivation greenhouse 1, because the air pressure in the plant cultivation room is higher than the air pressure outside the plant cultivation room, insects and pathogenic bacteria, etc., can be prevented from entering the plant cultivation room from the gap and the like of the plant cultivation room.

As another mode of the plant cultivation greenhouse 1 applicable to the invention, the heat insulator 15 is a laminated sheet 150 formed by laminating an aluminum foil on a sheet substrate. According to the plant cultivation greenhouse 1, because the heat insulator 15 is a laminated sheet 150 formed by laminating an aluminum foil on a sheet substrate, the wall 11 and the roof 12 can be formed by the heat insulator 15 that is cheap and has high thereto-insulating property.

As another different mode of the plant cultivation greenhouse 1 applicable to the invention, there exists an air-conditioning device 30 that can carry out air conditioning in the plant cultivation room 10. According to the plant cultivation greenhouse 1, an atmosphere of the temperature and humidity optimal for the growing of the plant 2 can be formed inside the plant cultivation room 10, thereby prompting the growing of the plant 2.

### LIST OF THE REFERENCE NUMBERS

1 plant cultivation greenhouse
2 plant
10 plant cultivation room
11 wall
12 roof
13 floor
15 heat insulator
151 sheet material
152 metal foil (aluminum foil)
20 carbon dioxide supply means
30 air-conditioning device

1.-7. (canceled)

8. A plant cultivation greenhouse, comprising:
a plant cultivation room;
a carbon dioxide supply means; and
an air-conditioning device for carrying out air conditioning inside the plant cultivation room;
wherein at least one of a wall and a roof of the plant cultivation room is formed by a heat insulator;
wherein the carbon dioxide supply means supply outside air containing carbon dioxide into the plant cultivation room from outside of the plant cultivation room;
wherein the carbon dioxide supply means comprise means for heating or cooling the outside air; and
wherein a temperature inside the plant cultivation room set in the air-conditioning device is related to a temperature of the outside air supplied by the carbon dioxide supply means.

9. The plant cultivation greenhouse according to claim 8, wherein
the carbon dioxide supply means further comprise a humidity control means for humidifying or dehumidifying the air.

10. The plant cultivation greenhouse according to claim 8, wherein
the means for heating or cooling the air comprise:
a fluid tank that seals a fluid; and
a pipeline that goes through the fluid tank and realizes air circulation.

11. The plant cultivation greenhouse according to claim 9, wherein
the humidity control means are configured to humidify or dehumidify the air inside the pipeline.

12. The plant cultivation greenhouse according to claim 8, wherein
the carbon dioxide supply means are connected to an air-supply hole of the plant cultivation greenhouse.

13. The plant cultivation greenhouse according to claim 8, wherein
the air-conditioning device comprises an indoor unit and an outdoor unit, wherein the indoor unit is fixed to inside of the plant cultivation greenhouse.

14. The plant cultivation greenhouse according to claim 8, wherein
a humidity inside the plant cultivation room set in the air-conditioning device is related to a humidity of the outside air supplied by the carbon dioxide supply means.

15. The plant cultivation greenhouse according to claim 8, wherein
the carbon dioxide supply means supply the outside air into the plant cultivation room, so that the plant cultivation room has a positive pressure inside.

16. The plant cultivation greenhouse according to claim 15, wherein
the positive pressure is achieved by an air vent hole sized so that an air discharged from the plant cultivation room is less than an outside air supplied into the plant cultivation room.

17. The plant cultivation greenhouse according to claim 8, wherein
the heat insulator comprises:
a pair of sheets that are spaced apart and provided opposite to each other; and
an enclosed space provided between the pair of sheets;
wherein an air is sealed in a non-flowable mode in the enclosed space; and
wherein each of the pair of sheets comprises an aluminum foil.

18. A plant cultivation method comprising a step of cultivating plants inside the plant cultivation room of the plant cultivation greenhouse according to claim 8.

19. The plant cultivation method according to claim 18, wherein
the plant cultivation greenhouse comprises an air-conditioning device;
the plant cultivation method comprising:
placing different types of plants in the vicinity of an air-supply hole of the carbon dioxide supply means and in the vicinity of the air-conditioning device; and
setting air of different temperature and humidity to be blown out from the carbon dioxide supply means and the air-conditioning device so as to attain an atmosphere of a temperature and/or humidity suitable for each plant.
